(19) United States
(12) Patent Application Publication
(10) Pub. No.: US 2025/0276619 A1
(43) Pub. Date: Sep. 4, 2025

(54) BEARING ASSEMBLY, VEHICLE SEAT WITH AN EASY-ENTRY FUNCTION AND METHOD OF MANUFACTURING THE BEARING ASSEMBLY

(71) Applicant: Brose Fahrzeugteile SE & Co. Kommanditgesellschaft, Coburg, Coburg (DE)

(72) Inventors: Andre HAMPE, Neuhaus am Rennweg (DE); Peter SCHWARZE, Ahorn (DE); Sebastian TIETZ, Schleusingen (DE)

(21) Appl. No.: 19/068,179

(22) Filed: Mar. 3, 2025

(30) Foreign Application Priority Data
Mar. 1, 2024 (DE) 10 2024 201 970.4

(51) Int. Cl. B60N 2/235

(52) U.S. Cl. CPC B60N 2/235

(57) ABSTRACT

A bearing subassembly for a vehicle seat with an easy-entry function has a gear mechanism, in particular a tumbler gear mechanism for adjusting the inclination of a seat backrest. A ring gear extends along a center axis in the axial direction. A bearing pin is formed on an end wall of the ring gear and it has a bearing face for pivotably supporting the seat backrest. The bearing pin and the ring gear together form a monolithic bearing ring gear, which is formed in particular by cold-extrusion with subsequent machining postprocessing. As a result of the monolithic configuration, a high level of stability is enabled with small tolerances.

The invention relates to a bearing subassembly for a vehicle seat with an easy-entry function, to such a vehicle seat and to a method for producing such a bearing subassembly.

Such seats with an easy-entry function are used in order to facilitate access to a rear seat row, for example, to a second or third seat row. For access to seats in the rear area or also in a third seat row, the seat backrest of the front seat is folded over (so-called easy-entry function). The seat backrest is usually also provided with a normal inclination adjustment in addition to this folding-over mechanism. In order to allow the seat backrest to be folded over, a locking mechanism is unlocked and the backrest can be pivoted about a bearing location and thereby folded over. Usually a drive mechanism having a gear mechanism, usually a tumbler gear mechanism, is configured for the normal inclination adjustment.

In order to enable these functions, that is to say, on the one hand, folding the seat backrest over and, on the other hand, normal inclination adjustment, there are known on the market different solution concepts for bearing subassemblies in which a gear mechanism, in particular a tumbler gear mechanism, has for adjusting the inclination an outer wheel which extends along a center axis and in an axial direction and which is in the form of a ring gear. It typically has an inner toothing which meshes with an outer toothing of an inner wheel. Two such bearing subassemblies which are connected to each other via a synchronizing shaft, also referred to as a recliner shaft, are generally fitted opposite each other on the vehicle seat.

In the axial direction, a bearing region for supporting a backrest component of the seat backrest generally adjoins this ring gear.

Another concept is schematically set out in connection with FIG. 4. FIG. 4 shows a half-section of a ring gear 2 which extends along a center axis M in an axial direction A. The ring gear 2 is in the form of a stamped part, wherein a stepped ring 4 is stamped out of a component which is initially substantially disk-shaped and is displaced slightly in the axial direction A. The stepped ring 4 remains connected to the remaining component via a toothing 6 in a positive-locking manner. A bearing ring 7 is formed as a bearing region on this stamped-out ring 4 which is displaced in the axial direction. A backrest component 8 which is secured in the axial direction via a welded-on axial securing member 9 is supported thereon.

Both concepts have disadvantages, in particular also with regard to the stability, particularly with regard to sufficient crash safety. Thus, the variant illustrated in FIG. 4 shows weaknesses as a result of the stamping and in particular only a small material thickness in the connection region of the toothing between the stamped-out and axially displaced ring 4 and the outer remaining component. As a result of production, the bearing width is also limited. As a result of the welded-on axial securing member 9 and the consequently necessary weld seam, there is further axial play for the bearing of the backrest component 8 in an undesirable manner.

As a result of the bearing component which is welded on separately in the first variant, a bearing diameter is usually limited. An increase in the bearing diameter for increasing the stability, firstly, leads to cost increases and, secondly, the tolerances deteriorate, for example, with regard to the concentricity of the welded-on bearing component relative to the ring gear, which has a negative effect on the overall quality. This variant also has a great axial extent, which is disadvantageous with constrained structural spaces.

On this basis, an object of the invention is to provide a bearing subassembly for a vehicle seat with an easy-entry function, such a vehicle seat and a method for producing such a bearing subassembly which has a high level of stability.

The object is achieved according to the invention by a bearing subassembly for a vehicle seat with an easy-entry function with a gear mechanism, in particular a tumbler gear mechanism for adjusting the inclination of a part of the seat, in particular a seat backrest, wherein the gear mechanism has a ring gear which extends along a center axis in the axial direction and which generally forms an outer wheel of the gear mechanism. A bearing pin having a bearing face for pivotably supporting the seat backrest which forms with the ring gear a monolithic bearing ring gear is formed on an end wall of the ring gear.

The object is further achieved by a vehicle seat having such a bearing subassembly which is formed with an easy-entry function. Particularly, a seat backrest is attached to a seat member in a pivotably movable manner via the bearing subassembly. In this instance, generally two such bearing subassemblies are fitted opposite each other laterally on the vehicle seat.

The object is finally further achieved by a method for producing such a bearing subassembly, wherein a monolithic bearing ring gear which has an end wall with a bearing pin which is formed thereon and which has a bearing face is produced.

The advantages set out below with regard to the bearing subassembly and preferred embodiments are also intended to be transferred to the vehicle seat and/or the method accordingly. This also applies similarly the other way round, that is to say the advantages set out with regard to the method or the vehicle seat and preferred embodiments are also intended to be transferred to the bearing subassembly accordingly.

Therefore, this bearing ring gear has initially a double function and forms part of the gear mechanism, in particular the outer wheel, for adjusting the inclination, wherein at the same time, as a result of the monolithic component, the bearing pin is also formed. The bearing ring gear has at the inner side thereof in particular an inner toothing which meshes with an outer toothing of an inner wheel of the gear mechanism in the fitted state.

As a result of the monolithic integration of the bearing function in the ring gear, a particularly high level of stability is achieved. The term “monolithic” is intended to be understood here to mean the configuration from one piece, that is to say without several components being subsequently connected, for example, by welding or another materially engaging connection. In particular, a common material structure of the material of the monolithic bearing ring gear is formed. In particular, a stamping operation is dispensed with for forming the geometry of the monolithic bearing ring gear, in particular for forming the bearing pin, since in this instance a material separation and also material weakening are carried out.

The bearing ring gear generally comprises here a metal, in particular with a great hardness, in particular steel.

As a result of the configuration as a monolithic component, substantially more degrees of design freedom which can be exploited with regard to a configuration of particularly good stability are produced. In comparison with a stamped ring gear, as described in the introduction, in particular weakened areas can be avoided. In this monolithic component, a bearing diameter can also be selected to be large without any problems without additional costs thereby being incurred. As a result of the monolithic configuration, at the same time a high level of tolerance precision is further enabled even with great bearing diameters.

In an advantageous configuration, the monolithic bearing ring gear is in the form of a massively formed component here, in particular a cold-extruded component. With a cold-extrusion method, it is possible to produce the monolithic bearing ring gear from a hard material with a high level of rigidity so that the mechanical stability of this bearing ring gear is particularly good. The cold-extrusion method is preferred to alternative production methods for forming a monolithic component, such as, for example, a casting method or a 3D printing method, which may be considered in principle, however.

In such a massive formation, particularly cold-extrusion, an unprocessed component with a predetermined geometry is produced by massive formation during a pressing method and generally without external heating of the blank from a disk-shaped blank, for example, as the initial component. The unprocessed component already has in this case at least approximately the desired geometry of the bearing ring gear with an unprocessed pin which is formed on an end wall and which is in particular conical. The unprocessed component is therefore itself already in the form of a ring gear which is particularly formed on an inner side with the inner toothing and which already has the unprocessed pin on the end wall. During this pressing method, a flow of material occurs so that the geometry is formed. During the pressing method, a pressing mold which predetermines the desired geometry of the unprocessed component and in which the initial component is pressed is used as an auxiliary means.

As a result of production, specific peripheral conditions have to be considered for the forming of the unprocessed component in order, for example, to allow the flow of the material into the desired regions and particularly in order not to generate any damage in the inner material structure, such as, for example, (micro) cracks or the like. Thus, for example, sharp edges or powerful redirections, etc., have a negative effect on the quality of the produced unprocessed component.

In an advantageous embodiment, therefore, during the production method as described above, the unprocessed component is initially formed, the shape of which is merely made to approximate to the desired final form of the bearing ring gear. This particularly relates to the configuration, which is particularly critical with regard to tolerances, of the bearing pin with the bearing face. As described above, initially at the location of the subsequent bearing pin only one unprocessed pin, which is in particular in the form of a cone and therefore tapers conically, is formed with an overdimension. This unprocessed pin is subsequently reprocessed with cutting so that material is removed and the bearing face is produced.

Therefore, the bearing face is generally formed by cutting reprocessing of the unprocessed pin and therefore also of the bearing pin. The term “cutting processing” is generally intended to be understood to mean production methods in which material is mechanically removed. In particular, turning, in particular round-turning is intended to be understood thereby. Grinding is also included by cutting reprocessing.

In an advantageous embodiment, the bearing pin is formed in a stepped manner in the direction of the center axis, wherein a support ring which is offset radially inwardly therefrom is subsequently formed on the bearing face. This is also preferably formed by cutting reprocessing.

In an advantageous embodiment, an axial securing element, in particular a securing ring, is fitted to this support ring at the circumferential face thereof, in order to axially secure a seat component which is supported on the bearing pin. The seat component is particularly a backrest component, particularly an annular flange which is configured in the manner of an adapter, on which the remaining members of the seat backrest are secured.

As a result of the production as a monolithic, three-dimensional component, in particular produced by massive formation, this repeatedly stepped configuration of the bearing pin is first enabled. The particular advantage of the additional support ring which forms a front end of the bearing ring gear in the axial direction is evident in that a particularly high level of precision during positioning in the axial direction is achieved so that as far as possible a bearing without play in the axial direction is achieved. The securing element is fixed in position in this instance on the support ring, in particular by welding, wherein the weld seam is formed particularly between the securing element and the support ring, in particular in a radial intermediate space between these two components. A high axial positioning accuracy is thereby achieved. In particular, the securing element abuts an axial, annular end wall of the bearing pin which forms the step between the bearing face and the circumferential face of the support ring and which connects these two faces to each other in the radial direction.

In a preferred embodiment, the end wall is configured to be smooth on an inner side, which is opposite the bearing pin, of the bearing ring gear and without any recesses. In a preferred embodiment, this inner side therefore forms a planar face which is oriented vertically with respect to the axial direction. A particularly high level of stability is thereby achieved. Such a smooth configuration is not possible in the known configuration, which is described in connection with FIG. 4, with the stamped ring gear and the further formed bearing ring since it is formed by pressing out a central part-region so that of necessity the bearing region is simply in the form of a hollow ring. Conversely, the entire bearing region, that is to say the bearing pin, is formed in a massive manner in this case and has in particular no hollow space and is therefore not in the form of a hollow pin.

In a preferred embodiment, the bearing ring gear is generally free from weakened regions. This is intended to be understood to mean that a (minimal) wall thickness which the end wall has in a region with radial spacing from the bearing pin is not undershot in a transition region which is in abutment against the bearing pin. The particularly minimal wall thickness which virtually defines the comparison reference for a potential weakened region is measured with radial spacing from the bearing pin and in particular in a radially outermost region of the end wall before an axially extending and typically bush-like portion, on the inner wall of which the inner toothing is formed, abuts it.

This is because the particular advantage of the monolithic configuration involves particularly the fact that—for example, in comparison with the stamped ring gear, as explained in the introduction in connection with FIG. 4 with respect to the prior art—no weakened locations are formed particularly in such a transition region to the bearing pin, as occurs as a result of production by the axial displacement of the stamped-out component.

In a preferred embodiment, a bearing diameter of more than 40 mm and in particular more than 45 mm is formed by the bearing face. The bearing face has, for example, a bearing diameter of up to 55 mm and preferably of 47 mm. As a result of the configuration as a monolithic component, it is possible in a particularly simple embodiment to implement such great bearing diameters without disadvantageous tolerance effects being a risk. As a result of the great bearing diameter, overall a high level of stability and therefore in particular also a high level of crash safety are achieved.

The bearing subassembly further has a releasable locking mechanism, via which pivotability of the seat backrest about the bearing pin is blocked and, where necessary, in order to allow the easy-entry function, can be released. The locking mechanism is often also referred to for short as a lock is regularly present in such easy-entry seats. It is actuated, for example, by a Bowden cable mechanism.

In an advantageous embodiment, a shaft is further guided through the ring gear and in particular a synchronizing shaft which is used to synchronize the rotation position with a second opposite bearing subassembly.

In the mounted vehicle seat, therefore, two opposite bearing subassemblies are connected to each other with this synchronizing shaft which is also referred to as a recliner shaft.

One exemplary embodiment of the invention is explained in greater detail below with reference to the Figures, in which:

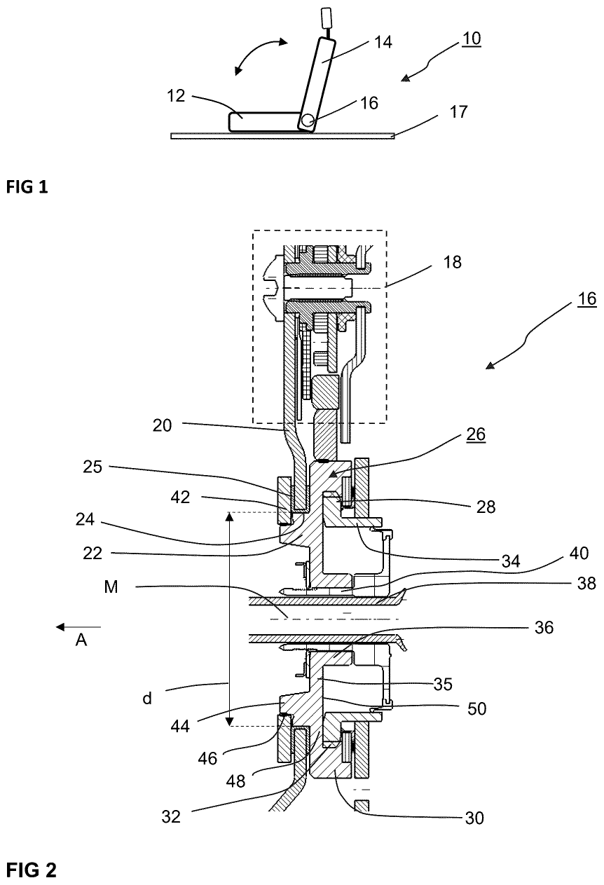

FIG. 1 shows a simplified side view of a vehicle seat,

FIG. 2 shows a sectioned view through a bearing subassembly,

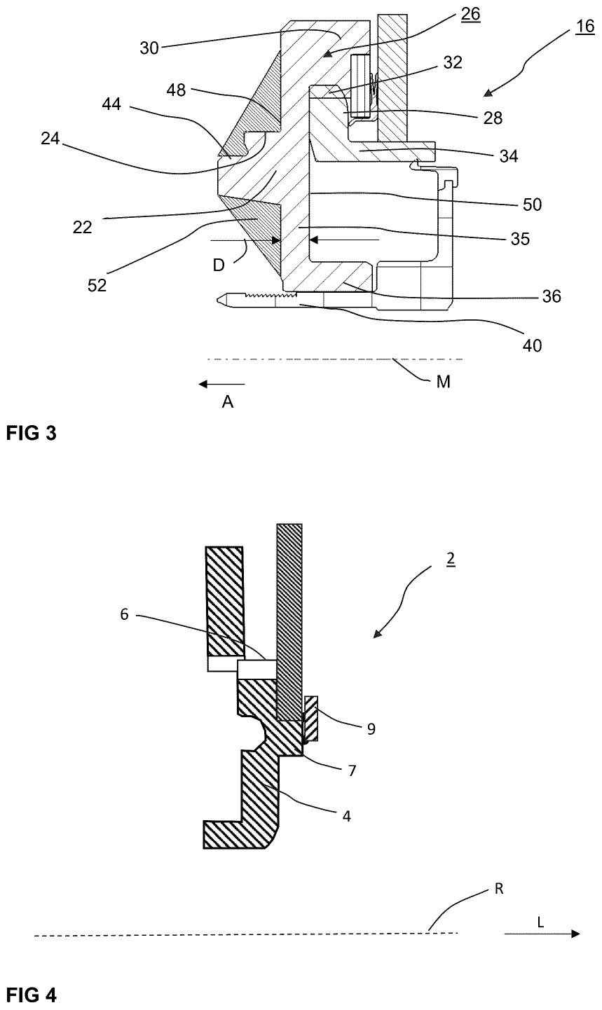

FIG. 3 shows an enlarged illustration in the region of a bearing ring gear of the bearing subassembly, and

FIG. 4 shows a known bearing subassembly.

FIG. 1 illustrates a vehicle seat 10 in a highly simplified manner. It has a seat member 12 and a seat backrest 14 which is attached to the seat member 12 in a pivotably movable manner via two opposite and peripherally arranged bearing subassemblies 16. The vehicle seat 10 is fitted on a rail system 17 for longitudinal adjustment. The vehicle seat 10 is configured with an easy-entry function and can—in addition to a normal adjustment of the inclination of the seat backrest 14—be folded over forward in the direction toward the seat member 12 along the double-headed arrow. To this end, a locking mechanism 18, via which the pivotability is released, has to be released. This locking mechanism 18 is known in principle and is formed in FIG. 2 by the region which is bounded by the dashed rectangle.

For the pivotability of the seat backrest 14, a backrest component 20 is supported in a pivotably movable manner on a bearing pin 22 on a radial bearing face 24 (annular face) of the bearing pin 22. The bearing face 24 defines a bearing diameter d which is particularly greater than 45 mm. For the bearing, another bearing bush 25 in which the backrest component 20 is inserted is arranged in the exemplary embodiment. The bearing bush 25 is of U-shaped form when viewed as a half-section. The backrest component 20 is an adapter which is configured in the manner of a flange and on which the remaining components of the seat backrest 14 are secured.

The bearing pin 22 is part of a monolithic bearing ring gear 26 which is in the form of a cold-extruded part. It forms an outer wheel of a gear mechanism 28 which is usually in the form of a tumbler gear mechanism, also referred to as a tumbler fitting. The bearing ring gear 26 has to this end a typically cylindrical bush member 30 which has at the inner covering face thereof an inner toothing 32. An inner wheel 34 with a corresponding outer toothing meshes therewith.

In the axial direction A, the bush member 30 is delimited by an end wall 35 which extends in the vertical direction and from which the bearing pin 22 projects. The bearing pin is generally configured in an annular manner.

The bearing ring gear 26 generally extends along a center axis M in the axial direction A. The bearing ring gear 26 is arranged concentrically with respect to this center axis M.

The bearing ring gear 26 forms a central, bush-like bearing portion 36 as a component of the monolithic bearing ring gear 26, through which a synchronizing shaft 38 is guided in the exemplary embodiment. In the mounted state, this shaft connects two opposite bearing subassemblies 16 to each other and ensures an identical rotation position of the two bearing subassemblies 16.

The synchronizing shaft 38 is guided here through a separate shaft bush 40 which is inserted in the bush-like bearing portion 36.

The backrest component 20 is secured in the axial direction A by an axial securing element 42 which is in particular in the form of an annular disk. The axial securing element 42 is fixed to the bearing pin 22 at a support ring 44 at the end, in particular by a weld 46. It is formed on a radial circumferential face of the support ring 44 between the ring and the securing element 42. It is thereby possible to achieve a high axial positioning accuracy of the securing element 42, whereby the backrest component 20 is supported in an axially play-free manner.

The structure of the monolithic bearing ring gear 26 can particularly also be seen clearly with reference to the enlarged illustration according to FIG. 3:

In conclusion, the bearing ring gear 26 is formed as a monolithic component in the exemplary embodiment by the following components:

The radially external bush member 30 with the inner toothing 32, the opposite bush-like bearing portion 36 which is formed on the radially inner side, the end wall 35 which connects the bush member 30 and the bearing portion 36 to each other and the bearing pin 22 which projects from the end wall 35 in the axial direction A. In total, one annular hollow space in which the inner wheel 34 is arranged is formed between the bush member 30 and the bearing portion 36.

The bearing pin 22 is configured in a stepped manner with a first step which begins at the end wall 34 with the bearing face 24. A second step which forms the support ring 44 on the circumferential face of which the securing element 42 is fitted adjoins it in a state offset radially inwardly. Said securing element adjoins particularly directly against a radially extending annular face which connects the circumferential face to the bearing face 24.

This monolithic bearing ring gear 26 is particularly in the form of a cold-extrusion component with subsequent cutting reprocessing. As a result of this production method, it is possible to achieve a particularly stiff and stable construction. It should be emphasized that the bearing ring gear 26 is free from weakened regions, that is to say that in particular in a transition region 48 from the end wall 35 into the bearing pin 22 no material tapering is present. This transition region is understood by the region, which directly adjoins in the radial direction, of the end wall 35.

The end wall 35 preferably has in the exemplary embodiment a constant, uniform thickness D. It should be emphasized that this thickness D is not reduced in the transition region 48, as is the case, for example, in the known configuration, as explained in connection with FIG. 4.

It should further be emphasized that the entire bearing pin 22 is formed in a massive manner and not in the form of a hollow element with an internal hollow space. In a preferred embodiment, the inner side 50, which is opposite the bearing pin 22, of the end wall 35 is free from a recess which extends into the bearing pin 22. In particular, this inner side 50 is in the form of a planar face which extends continuously from the bearing portion 36 in the radial direction as far as the bush member 30.

In order to produce the bearing ring gear 26, a sequence is carried out as follows.

Initially, from a blank, which is not illustrated in greater detail here and which is configured in particular in the manner of a disk and particularly a perforated disk, an unprocessed component 52 is formed by massive formation, particularly by cold-extrusion, wherein the bearing pin 22 is not yet formed, but instead is merely in the form of a particularly conically tapering unprocessed pin 54, as illustrated in FIG. 3 by the hatched, conical part-regions. The other contour of the bearing ring gear 26, that is to say particularly the contour with the bush member 30 and the bearing portion 36, the inner toothing 32 and the smooth inner side 50 are preferably already formed in the unprocessed component 52.

Subsequently, the hatched conical part-regions are removed by cutting reprocessing, in particular by turning, so that the stepped configuration of the bearing pin 22 with the bearing face 24 and the support ring 44 is achieved.

### LIST OF REFERENCE NUMERALS

2 Ring gear
4 Ring
6 Toothing
7 Bearing ring
8 Backrest component
9 Axial securing
10 Vehicle seat
12 Seat member
14 Seat backrest
16 Bearing subassembly
17 Rail system
18 Locking mechanism
20 Backrest component
22 Bearing pin
24 Bearing face
25 Bearing bush
26 Bearing ring gear
28 Gear mechanism
30 Bush member
32 Inner toothing
34 Inner wheel
35 End wall
36 Bearing portion
38 Synchronizing shaft
40 Shaft bush
42 Axial securing element
44 Support ring
46 Weld
48 Transition region
50 Inner side
52 Unprocessed component
R, M Center axis
A Axial direction
d Bearing diameter
D Wall thickness

1-13. (canceled)

14. A bearing subassembly for a vehicle seat with an easy-entry function, the bearing subassembly comprising:
a gear mechanism, being a tumbler gear mechanism for adjusting an inclination of a seat backrest of the vehicle seat, said gear mechanism having a ring gear which extends along a center axis in an axial direction;
a bearing pin having a bearing face for pivotably supporting the seat backrest, said bearing pin being formed on an end wall of said ring gear and said bearing pin together with said ring gear forming a monolithic bearing ring gear.

15. The bearing subassembly according to claim 14, wherein said monolithic bearing ring gear is a massively formed component.

16. The bearing subassembly according to claim 15, wherein said monolithic bearing ring gear is a cold-extruded component.

17. The bearing subassembly according to claim 14, wherein said bearing face is formed by machining reprocessing of the bearing pin.

18. The bearing subassembly according to claim 14, wherein said bearing pin is formed with steps in a direction of the center axis to define an offset support ring on said bearing face.

19. The bearing subassembly according to claim 18, further comprising an axial securing element affixed on a circumferential face of said support ring for axially securing a seat component that is supported on said bearing pin.

20. The bearing subassembly according to claim 14, wherein said end wall of said bearing ring gear has a smooth inner side, opposite said bearing pin, without any recesses formed therein.

21. The bearing subassembly according to claim 14, wherein said bearing ring gear is free of weakened regions and said end wall has, radially outwardly from said bearing pin, a given minimum wall thickness which is not undershot in a transition region directly abutting said bearing pin radially.

22. The bearing subassembly according to claim 14, wherein said bearing face has a bearing diameter of more than 40 mm.

23. The bearing subassembly according to claim 22, wherein said bearing diameter is greater than 45 mm.

24. The bearing subassembly according to claim 14, which further comprises a releasable locking mechanism configured to block a pivotability of the seat backrest about the bearing pin.

25. The bearing subassembly according to claim 14, which further comprises a shaft projecting through said bearing ring gear.

26. The bearing subassembly according to claim 25, wherein said shaft is a synchronizing shaft for synchronizing with a second opposite bearing subassembly.

27. A vehicle seat with an easy-entry function, the vehicle seat comprising:
a seat member and a seat backrest pivotably attached thereto; and
a bearing subassembly according to claim 14.

28. A method for producing a bearing subassembly according to claim 15, the method which comprises: producing a monolithic bearing ring gear having an end wall with a bearing pin formed on the end wall and defining a bearing face.

29. The method according to claim 28, which comprises:
initially forming a blank with an overdimension relative to the bearing ring gear to be produced; and
subsequently removing material from the blank by machining the blank and forming the bearing face.

30. The method according to claim 29, which comprises forming the blank by a cold extrusion of a disk-shaped blank to form an unprocessed component with a conical pin at an end wall thereof, and subsequently removing material by machining to form the bearing face.
